(19) United States
(12) Patent Application Publication
(10) Pub. No.: US 2006/0140369 A1
(43) Pub. Date: Jun. 29, 2006

(54) Network usage analysis system using revenue from customers in allocating reduced link capacity and method

(76) Inventors: Jorn Altmann, Berkeley, CA (US); Srinivasan Jagannathan, Carpinteria, CA (US); Lee Rhodes, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/021,675

(22) Filed: Dec. 23, 2004

(51) Int. Cl. H04M 15/00

(52) U.S. Cl. 379/114.13; 379/114.03

(57) ABSTRACT

A network usage analysis system includes a data collector that is coupled to a network comprising a plurality of links. The data collector collects usage data corresponding to an identification of subscribers using a failed link and corresponding to an identification of a pricing plan to which subscribers using the failed link belong. The system also includes a system server coupled to the data collector. The system server receives the usage data from the data collector receives identification of a link failure, receives pricing plan information identifying amounts paid by subscribers for service, and receives pricing plan information identifying an amount refunded to subscribers for less than full service. The system server calculates revenue generated from each of the subscribers using a failed link and allocates a reduced capacity to the subscribers using the failed link in a manner to maximize revenue.

### CROSS-REFERENCE TO RELATED APPLICATIONS

This application is related to the following concurrently filed U.S. patent application Ser. No. ______, Docket No. 200208403-1; Ser. No. ______, Docket No. 200208404-1; Ser. No. ______, Docket No. 200208405-1; and Ser. No. ______ Docket No. 200205880-1, all of which are incorporated herein by reference.

### BACKGROUND OF THE INVENTION

Network systems are utilized as communication links for everyday personal and business purposes. With the growth of network systems, particularly the Internet and wireless telephone networks, and the advancement of computer hardware and software technology, network use ranges from simple communication exchanges such as electronic mail to more complex and data intensive communication sessions such as web browsing, electronic commerce, and numerous other electronic network services such as Internet voice, and Internet video-on-demand.

Network usage information does not include the actual information exchanged in a communications session between parties, but rather includes metadata (data about data) information about the communication sessions and consists of numerous usage detail records (UDRs). The types of metadata included in each UDR will vary by the type of service and network involved, but will often contain detailed pertinent information about a particular event or communications session between parties such as the session start time and stop time, source or originator of the session, destination of the session, responsible party for accounting purposes, type of data transferred, amount of data transferred, quality of service delivered, etc. In telephony networks, the UDRs that make up the usage information are referred to as a call detail records or CDRs. In Internet networks, usage detail records do not yet have a standardized name, but in this application they will be referred to as internet detail records or IDRs. Although the term IDR is specifically used throughout this application in an Internet example context, the term IDR is defined to represent a UDR of any network.

Network usage information is useful for many important business functions such as subscriber billing, marketing and customer care, and operations management. Network usage data reporting systems are utilized for collecting, correlating, and aggregating network usage information as it occurs and creating UDRs as output that can be consumed by computer business systems that support the above business functions. Examples of these computer business systems include billing systems, marketing and customer relationship management systems, customer churn analysis systems, and data mining systems.

Especially for Internet networks, several important technological changes are key drivers in creating increasing demand for timely and cost-effective analysis of Internet usage information or the underlying IDRs.

One technological change is the dramatically increasing Internet access bandwidth at moderate subscriber cost. Most consumers today have only limited access bandwidth to the Internet via an analog telephony modem, which has a practical data transfer rate upper limit of about 56 thousand bits per second. When a network service provider's subscribers are limited to these slow rates there is an effective upper bound to potential congestion and overloading of the service provider's network. However, the increasing wide scale deployments of broadband Internet access through digital cable modems, digital subscriber line, microwave, and satellite services are increasing the Internet access bandwidth by several orders of magnitude. As such, this higher access bandwidth significantly increases the potential for network congestion and bandwidth abuse by heavy users. With this much higher bandwidth available, the usage difference between a heavy user and light user can be quite large.

Another technological change is the rapid growth of applications and services that require high bandwidth. Examples include Internet telephony, video-on-demand, and complex multiplayer multimedia games. These types of services increase the duration of time that a user is connected to the network as well as requiring significantly more bandwidth to be supplied by the service provider.

Another technological change is the transition of the Internet from “best effort” to “mission critical”. As many businesses are moving to the Internet, they are increasingly relying on this medium for their daily success. This transitions the Internet from a casual, best-effort delivery service into the mainstream of commerce. Business managers will need to have quality of service guarantees from their service provider and will be willing to pay for these higher quality services.

Network usage analysis systems provide information about how the service provider's services are being used and by whom. This is vital business information that a service provider must have in order to identify fast moving trends, establish competitive prices, and define new services or subscriber class as needed.

For reasons stated above and for other reasons presented in greater detail in the Description of the Preferred Embodiment section of the present specification, more advanced techniques are required in order to more compactly represent key usage information and provide for more timely extraction of the relevant business information from this usage information.

### SUMMARY OF THE INVENTION

The present invention is a network usage analysis system. The system includes a data collector that is coupled to a network comprising a plurality of links. The data collector collects usage data corresponding to an identification of subscribers using a failed link and corresponding to an identification of a pricing plan to which subscribers using the failed link belong. The system also includes a system server coupled to the data collector. The system server receives the usage data from the data collector receives identification of a link failure, receives pricing plan information identifying amounts paid by subscribers for service, and receives pricing plan information identifying an amount refunded to subscribers for less than full service. The system server calculates revenue generated from each of the subscribers using a failed link and allocates a reduced capacity to the subscribers using the failed link in a manner to maximize revenue.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a block diagram of a network usage analysis system according to the present invention providing representation of network usage information and interactive usage analysis.

FIGS. 2A and 2B illustrate networks on which the network usage analysis system performs its analysis according to the present invention.

FIG. 3 is a flow diagram illustrating one exemplary embodiment of a method for analyzing-network usage using subscriber information according to the present invention.

FIG. 4 is a block diagram of an alternative embodiment a network usage analysis system according to the present invention providing representation of network usage information and interactive usage analysis.

FIG. 5 is a flow diagram illustrating one exemplary embodiment of a method for analyzing network usage according to the present invention including providing direct statistical representation of usage information, compact storage and real time interactive usage analysis.

### DESCRIPTION OF THE PREFERRED EMBODIMENTS

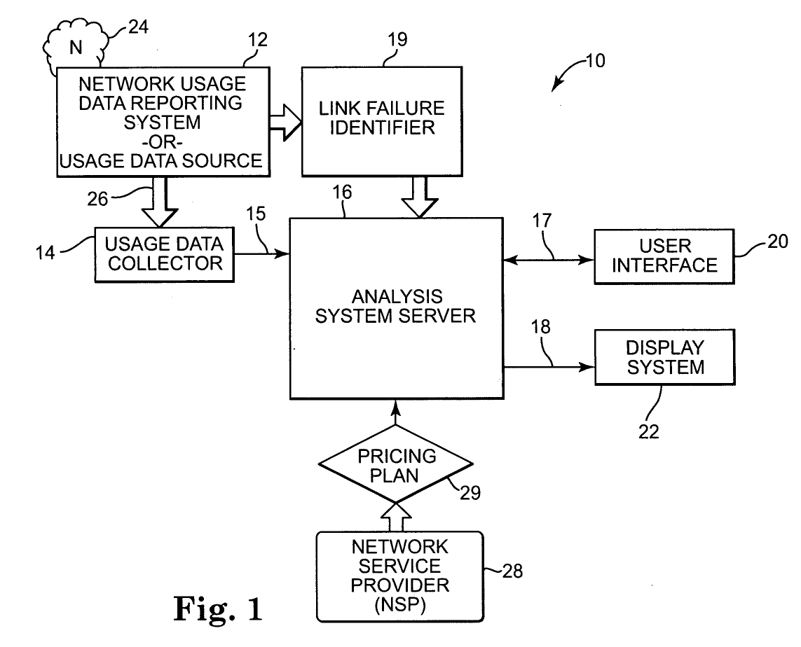

A network usage analysis system according to the present invention is illustrated generally at 10 in FIG. 1. Network usage analysis system 10 includes several main components, each of which comprises a software program. The main software program components of network usage analysis system 10 run on one or more computer or server systems. In one embodiment, each of the main software program components runs on its own computer system.

In one exemplary embodiment, network usage analysis system 10 includes a usage data collector 14, and a usage data analysis system server 16. Usage data collector 14 is coupled to usage data analysis system server 16 via communication link 15. Network usage analysis system 10 further includes user interface 20 and display system 22. User interface 20 and display system 22 are coupled to usage data analysis system server 16 via communication links 17 and 18, respectively.

Usage data collector 14 collects usage data 26. In one embodiment, the usage data 26 is a real time stream of IDRs generated from a usage data source or a network usage data reporting system 12, positioned on a network 24 (also indicated by an “N”). As used herein, a network usage data reporting system 12 is one type of usage data source. Alternatively, the IDRs may be received from a database or central data warehouse.

Usage data analysis system server 16 receives the usage data from usage data collector 14 via communication link 15. In one aspect, usage data collector 14 is separate from network usage data reporting system 12, and in another aspect, usage data collector 14 is part of a network usage data reporting system, such that the usage data analysis system server 16 receives the set of usage data directly from the network usage data reporting system. In another aspect, usage data collector 14 is part of the usage data analysis system server 16. Network 24 may be a plurality of server and host computer networks, such as the Internet, or may be a plurality of wireless networks, such as a cellular phone system. Such networks comprise links, as will be discussed in more detail below. On occasion, such links can fail and this failure is detected in network usage analysis system 10 by link failure identification 19.

Access to network 24 is provided and administered by network service providers, such as network service provider (NSP) 28. A variety of network service providers provide access to the network for end users, also referred to as subscribers or customers, and the network service providers maintain network 24 and access to network 24. In exchange for this service, network service providers charge the end user using a variety of prices and pricing plans designed to be attractive to the end user, but also generating revenue sufficient to maintain network access. NSP 28 has a pricing plan 29 that controls that fees that are charges to customers for access to network 24.

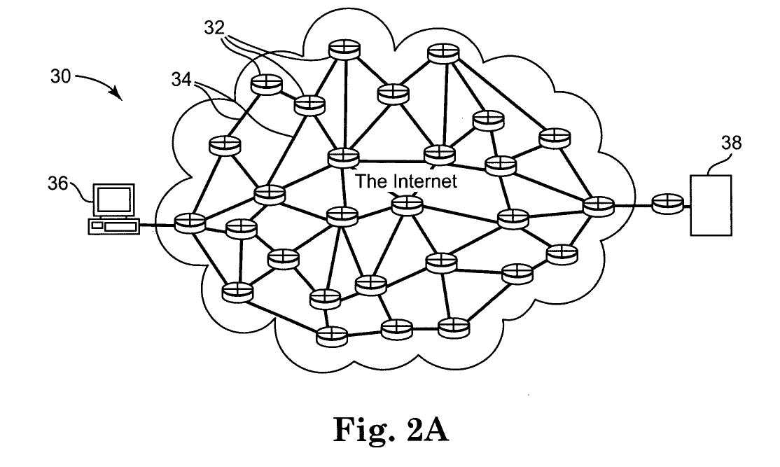

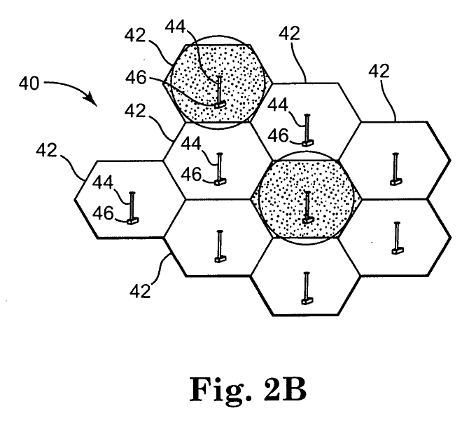

FIG. 2A illustrates an internet network 30. Internet 30 includes a plurality of routers 32 coupled to each other by a series of links 34. An access computer 36 and a host computer 38 are illustrated coupled to the network 30. Routers 32 determine the links 34 used to connect access computer 36 to host computer 38. There are many options of various links 34 that can be used to connect access computer 36 to host computer 38. Data, whether in the form of a web-page, a downloaded file or an e-mail message, travels over internet 30 as a packet-switching network system. In this system, the data in a message or in a file is broken up into packages, each about over 1,000 bytes long. Each of these packages gets a wrapper that includes information on the sender's address, the receiver's address, the package's place in the entire message, and how the receiving computer can be sure that the package arrived intact. Each data package, called a packet, is then sent off to its destination via the best available route—a route that might be taken by all the other packets in the message or by none of the other packets in the message. In other words, routers 32 may send packets from the same message or file over different links 34 to eventually arrive at the same destination.

For example, if there is a problem with one piece of equipment in internet 30 while a message is being transferred, packets can be routed around the problem, ensuring the delivery of the entire message. Routers 32 that make up the main part of internet 30 can reconfigure links 34, or the paths, that packets take because they look at the information surrounding the data packet, and they tell each other about line conditions, such as delays in receiving and sending data and traffic on various pieces'of the network. Consequently, some links 34 of network 30 may be more used than other links for sending packets.

FIG. 2B illustrates a wireless network 40. Wireless network 40 includes a plurality of cells 42, each of which include a tower 44 and associated transmission equipment 46 for sending and receiving signals. Although wireless network 40 differs in operation from internet 30, it similarly bundles and transmits data in packets that are transferred from tower 44 to tower 44 from a source to a destination. Again, the route or path that the packets take can differ, and some cells 42, or links, may be more used than others.

Usage analysis system 10 is used in association with networks such as networks 30 and 40 illustrated in FIGS. 2A and 2B. Usage data source 12 receives usage data 26 and passes usage data 26 to usage data collector 14. Usage data analysis system server 16 then receives and uses usage data 26 to perform analysis on the usage data 26. In addition to the type of service and network involved, information about a particular event or communications session between parties such as the session start time and stop time, source or originator of the session, destination of the session, responsible party for accounting purposes, type of data transferred, amount of data transferred, quality of service delivered, the usage data 26 in the present invention also includes information about the routes used, actual revenue generated from subscribers using those routes, and information about the pricing plan to which subscribers of the network service provider subscribes.

As inidicated previously, NSP 28 uses pricing plan 29 to generate revenue from its subscribers for use of network 24. A variety of pricing plans 29 may be used by NSP 28. Generally, these pricing plans can be separated into three categories: 1) flat-rate pricing plans, 2) connect-time-based pricing plans, and 3) use-based pricing plans. Historically, the first two pricing plans, flat-rate and connect-time pricing plans were more commonly used for network access, but are growing more out of favor because it is difficult to tailor the end user's actual use to the fees paid with these type of plans. If a flat fee is charged, those with low usage may be priced out of the service by the fees that would be required. If a connect-time-based plan is used, light-end users may be discouraged from exploring new internet media and curb growth. With a use-based plan, however, the particular fees paid by end users can be more closely tailored to actual use and quality of service demanded. Subscribers that are light users will be charged lower fees and those that are heavy users and demand high quality of service will be charged higher fees.

Usage-based pricing can also vary the fees paid by the consumer based on the end user's selection of various services. For example, a subscriber could choose a high bandwidth to be available to it such that it can expect higher performance in its network access. The user would pay an additional amount for this higher performance. Similarly, a user may also select that a higher priority level be available to it. In this way, when a network experiences high traffic, a user selecting a higher priority level will get priority and experience faster access to the network. Accordingly, the user will have to pay a higher amount for such higher priority level. Finally, a fee a user pays will also typically depend on the amount of data volume that a user sends and receives to and from the network over a particular to time. The higher volume of data generate by the user, the higher the fee will be charged by the network service provider.

When a network service provider provides network access with a usage-based pricing plan, the customers of the network service provider can be divided into segments. Those customers choosing peak bandwidth, high priority, and large amounts of volume of data, will be in a different customer segment, and pay a higher fee, than those choosing non-peak bandwidth, lower priority and lower volume of data. A network service provider may define multiple levels of customer segments and accordingly assign a corresponding fee for each customer segment. For example, there may be a premium service plan and a standard service plan.

Typically, when a network service provider experiences problems and cannot provide its subscribers with service at the proscribed levels, the service provider will have to rebate some of the subscribers' fee back to the subscriber until the service is returned to the proscribed levels.

In one embodiment, usage analysis system 10 collects and analyzes usage data 26, which includes information on the bandwidth, priority level, and amount of data volume used by customers, as well as information on the customer segment to which a particular customer belongs. Furthermore, NSP 28 has a particular pricing plan 29 for its customers, and this pricing plan 29 is provided to analysis system server 16. Analysis system server 16 receives and analyzes usage data 26 and pricing plan 29 to perform analysis that can be analyzed and displayed using user interface 20 and display system 22. With this data, analysis system server 16 can be used to analyze customer usage under pricing plan 29 and determine what steps can be taken to maximize revenue in the event of a link failure.

In one embodiment, usage analysis system 10 is used to make business decisions about a network based on an analysis of usage data 26 and the pricing plan 29 in the event of a link failure. As detailed above, network 24 is comprised of various links 34 or cells 42 (hereinafter collectively referred to as links 34 unless otherwise noted). These links 34 can experience failure from time to time. In some cases, the link failure can affect the service that NSP 28 is able to provide to its subscribers. For example, when multiple subscribers are using virtual paths over the same physical link 34, the physical link 34 will typically have sufficient capacity to handle transmission for all of the subscribers. When there is a link failure, however, the capacity of the link can be diminished such that it can no longer accommodate all users at their full transmissions. In this case, the NSP 28 must decide how to allocate the diminished link capacity among its subscribers.

Usage analysis system 10 may be used to maximize the revenue generated from its customers in allocating diminished link capacity among its subscribers. For example, NSP 28 has two customers: Premium A, belonging to a premium customer segment, and Standard B, belonging to a standard customer segment. As a premium subscriber, Premium A pays $1,000 every week for access to network 24 and has a peak transmission rate of 500 kbps. As a standard subscriber, Standard B pays $500 every week for access to network 24 and has a peak transmission rate of 250 kbps. Both Premium A and Standard B are using the same link 34 that has a capacity of 1 Mbps. Because of a link failure, the shared link 34 capacity is halved to 500 kbps. Now, NSP 28 must determine how to allocate this decrease capacity to its customers.

Using usage analysis system 10, usage data 26 is collected and provided to analysis system server 16. This information includes the customer segment to which each subscriber belongs. Analysis system server 16 also receives pricing information for pricing plan 29, such that the price paid by each subscriber and the peak transmission rate for each subscriber is known. The pricing plan information also includes calculations for reducing the fees subscribers pay in the case where the NSP provides less than full service. In addition, the NSP may have to refund money when peak rate of transmission is reduced. Analysis system server 16 also receives the identification of which link has experience a failure from link failure identifier 19. Using this information, analysis system server 16 can now calculate how to maximize its revenue in allocating the reduced capacity to its subscribers.

For example, in the scenario given for Premium A and Standard B, it is further provided that pricing plan 29 dictates that NSP 28 must return $1 for every kbps reduction from the usual peak rate and must discount the fee paid in an amount proportional to the reduced service. Thus, where the link capacity is halved to 500 kbps, NPS must decide whether to A) decrease the peak transmission rate of both subscribers, or B) simply deny service to one of the subscribers. For scenario A, system server 16 can calculate that if it reduces the peak transmission rate for both Premium A and Standard B, it will only generate $750 in revenue ($500 from Premium A, representing half its regular rate for half service and $250 from Standard B, representing half its regular rate for half service). In addition, under this scenario, NSP must also return $1 for each kbps reduction in the rate, or $375 ($250 to Premium A and $125 to Standard B) to its subscribers. Thus, scenario A produces a net of $375 to NSP 28.

For scenario B, system server 16 can calculate that if it denies service to Standard B and does not affect the peak transmission rate for both Premium A, it will generate $1000 in revenue ($1000 from Premium A, representing its regular rate for full service and $0 from Standard B, representing no rate for no service). In addition, under this scenario, NSP must also return $1 for each kbps reduction in the rate, or $250 ($0 to Premium A and $250 to Standard B) to its subscribers. Thus, scenario B produces a net of $750 to NSP 28, and therefore is a superior scenario to scenario A.

Thus, using customer usage data 26, pricing plan information, and the identification of a link failure, usage analysis system 10 can derive specific calculations that allow NSP 28 to maximize its revenues in the event of link failure that require an allocation of reduced capacity to occur.

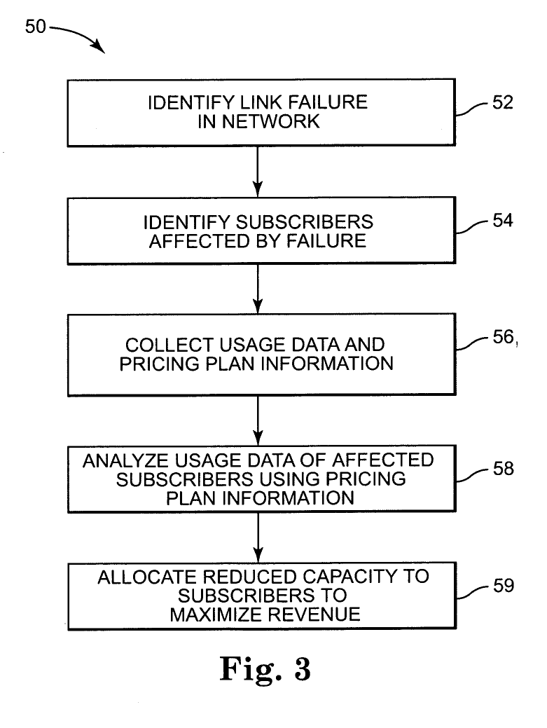

In FIG. 3, a flow diagram illustrating one exemplary embodiment of a method for analyzing network usage according to the present invention is shown generally at 50. Reference is also made to FIGS. 1, 2A and 2B. In step 52, a link failure in network 24 is identified. In step 54, the subscribers that are affected by the link failure are identified. Specifically, those subscribers that were relying on the failed link for transmission are identified so that an analysis relating to the allocation of reduced capacity will consider these subscribers.

In step 56, usage data is collected from the network and pricing plan information from the NSP, both for analysis of the allocation of reduced capacity. The type of usage data collected is that which can be generated from a network usage data reporting system or a usage data source 12. In one exemplary embodiment, the usage data 26 consists of a real time or real time stream of IDRs received from a network usage data reporting system. The usage data collector 14 collects usage data from the IDRs that may include the type of service and network involved, information about a particular event or communications session between parties such as the session start time and stop time, source or originator of the session, destination of the session, responsible party for accounting purposes, type of data transferred, a usage metric (e.g., bandwidth, megabytes, time), amount of data transferred, quality of service delivered, links used by the subscriber, information about the pricing plan to which the particular subscriber of the network service provider subscribes, including the bandwidth, priority level, amount of data volume used by customers, as well as the customer segment to which a particular customer belongs.

In step 58, the collected usage data 26 is analyzed in view of the pricing plan information for those subscribers affected by the link failure in order to calculate the affect reduction of services will have on the NSP's revenue. The analysis includes determining calculating how much loss of capacity must be distributed, to which subscribers the allocation must be made, how much revenue will be sacrificed in allocating the reduced capacity to each of the various affected subscribers, and how much credit must be returned to subscribers with reduced service.

In step 59 an allocation of the reduced capacity is made to the subscribers in a way that maximizes the revenue to the NSP. For example, usage analysis system 10 can be used by a network service provider to determine the best allocation of reduced capacity is simply to deny service to lower-paying subscribers and collect full revenue from higher paying subscribers, rather than to equally allocate the reduced capacity to all subscribers affected by the link failure.

Usage analysis system 10 accomplishes optimization of network resources in the form of allocation assessment of reduced capacity that is specifically tailored to the subscribers affected and specific to the revenues and pricing plans of the subscribers. With prior systems, business decisions such as allocation of reduced capacity of network services were made by only generally monitoring the overall network, and could not achieve such tailored optimization.

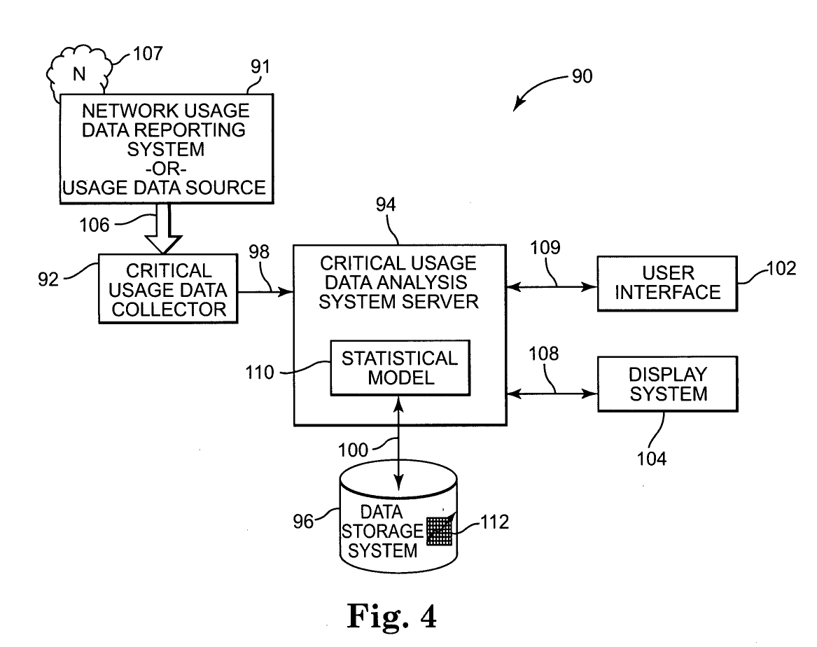

In another embodiment of the present invention, illustrated in FIG. 4, network usage analysis system 90 provides direct statistical representation of usage information and provides compact storage and real time, interactive usage analysis. The network usage analysis system 90 in accordance with the present invention provides for the use of statistical models and the storage of statistical data representative of critical usage data in lieu of storing the critical usage data, thereby allowing for real time interactive statistical analysis and greatly reducing usage data storage requirements. Since statistical models are stored and not the usage data itself, with the present invention the storage requirements do not grow with the amount of usage data. The storage requirements for the statistical models are a function of the complexity of the business to be modeled and the granularity of the desired results.

In one exemplary embodiment, network usage analysis system 90 includes a critical usage data collector 92, a critical usage data analysis system, server 94 and a data storage system 96. Critical usage data collector 92 is coupled to critical usage data analysis system server 94 via communication link 98. Data storage system 96 is coupled to critical usage data analysis system server 94 via communication link 100. Network usage analysis system 90 further includes user interface 102 and display system 104. User interface 102 and display system 104 are coupled to critical usage data analysis system server 94 via communication links 109 and 108 respectively.

Critical usage data collector 92 collects critical usage data (e.g., a set of critical usage data) from usage data 106. Preferably, the usage data 106 is a real time stream of network usage data records. In one embodiment, the usage data 106 is a real time stream of IDRs generated from a usage data source or a network usage data reporting system 91, positioned on a network 107 (also indicated by an “N”). As used herein, a network usage data reporting system 90 is one type of usage data source. Alternatively, the IDRs may be received from a database or central data warehouse.

One network usage data reporting system suitable for use with the present invention is commercially available under the tradename SMART INTERNET USAGE 2.01 (SIU 2.01), from Hewlett-Packard, U.S.A. Other network usage data reporting systems suitable for use with the usage analysis system in accordance with the present invention will become apparent to those skilled in the art after reading the present application.

Usage data analysis system server 94 receives the critical usage data from the critical usage data collector 92 via communication link 98. In one aspect, the critical usage data collector 92 is separate from a network usage data reporting system, and in another aspect, the critical usage data collector 92 is part of a network usage data reporting system, such that the critical usage data analysis system server 94 receives the set of critical usage data directly from the network usage data reporting system. In another aspect, the critical usage data collector 92 is part of the critical usage data analysis system server 94.

The critical usage data analysis system server 94 uses the set of critical usage data to perform predetermined network usage statistical analysis. In particular, a statistical model 110 is defined for solving a network usage related business problem. The critical usage data analysis system server 94 uses the critical usage data and the statistical model 110 to generate statistical data 112. The critical usage data analysis system server 94 operates to store the statistical data 112 in the data storage system 96. In one aspect, the statistical data is stored in the form of a table (e.g., a distribution table).

After storage of the statistical model 110, the set of critical usage data is no longer retained. In one aspect, the critical usage data analysis system server 94 is responsive to the user interface 102 for interactive analysis of the statistical model 110. Further, a graphical display of the statistical model 110 can be output to display system 104. One exemplary embodiment of interactive analysis of critical usage data using the statistical model 110 is described in related application INTERNET USAGE ANALYSIS SYSTEM AND METHOD, Ser. No. 09/548,124, filed Apr. 12, 2000, which is incorporated by reference herein.

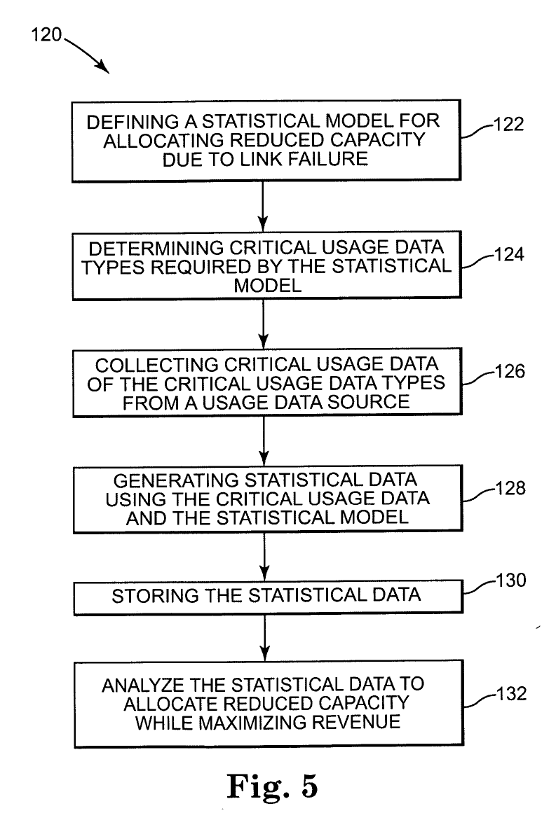

In FIG. 5, a flow diagram illustrating one exemplary embodiment of a method for maximizing revenue in allocating reduced system capacity according to the present invention is shown generally at 120. Reference is also made to FIG. 4. In step 122, a statistical model is defined for solving a network usage related business problem, such as maximizing revenue while allocating reduced system capacity caused by a link failure. Resolution of such a business problem can be based on an analysis of the subscribers affected by the reduced capacity, consideration of pricing plan of the NSP and the revenue generated by the affected subscribers, and consideration of the reduction in revenue from allocating reduced capacity to the subscribers.

In step 124, critical usage data types required by the statistical model are determined. The type of statistical model chosen is based on the network usage related business problem to be solved. By defining only critical usage data types required by the statistical model, the volume of usage data that needs to be collected is greatly reduced. For example, the critical usage data may be the subscribers affected by the link failure and the pricing plan to which the affected subscribers belong.

In step 126, critical usage data 98 of the critical usage data types are collected from usage data 106 that can be generated from a network usage data reporting system or a usage data source 91. In one exemplary embodiment, the usage data 106 consists of a real time or real time stream of IDRs received from a network usage data reporting system. A real time stream of IDRs is defined as a stream of IDRs that is “flushed” or transferred from a data storage location at regular and frequent intervals (e.g., which may be substantially instantaneous or, based on the usage data source, from seconds to minutes). The critical usage data collector 92 collects critical usage data from the IDRs that may actual usage by subscribers of particular network links and relative importance of those subscribers.

In step 128, statistical data representative of the critical usage data are generated. In particular, statistical data are generated using the critical usage data and the statistical model. The step of generating the statistical data can be done in real time.

In step 130, the statistical data are stored. The statistical data may be stored in various forms, such as in the form of a table or graph in volatile or nonvolatile memory. After storing of the statistical data, the critical usage data can be deleted, since it is not necessary to retain it for the selected network usage related business problem. As such, storing of the statistical data representative of the collected critical usage data in lieu of storing the critical usage data itself greatly reduces data storage requirements.

In step 132, the statistical data can be analyzed to produce a result addressing the network usage related business problem. Also, the statistical data may be stored in volatile memory (e.g., RAM) to provide for interactive analysis and presentation of results pertinent to a network usage related business problem. The statistical data may be stored and/or archived in non-volatile memory, such as a hard disk drive. In particular, the statistical model is used to determine/analyze usage characteristics. The statistical model may also be used for performing interactive analysis of the critical usage data via user interface 102. In particular, the statistical model may include one or more variable elements, wherein the variable elements are changeable via user interface 102 to interactively model network usage. The statistical model results can be graphically or otherwise displayed using display system 104.

For example, a user can be prompted via display system 104 to make additional decisions regarding the allocation of reduced capacity and see what affect the allocations will have on revenue to the NSP. The user could then be allowed to tray variations in the allocations to determine what the overall affect will be on revenue.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method for maximizing revenue to a network service provider that provides access for subscribers to a network system, which includes a plurality of links, comprising the steps of:
identifying a failed link in the network system, the failed link causing reduced transmission capacity over the failed link;
identifying affected subscribers, wherein the affected subscribers are those subscribers of the network service provider that transmit over the failed link;
collecting network subscriber usage data from the network for the affected network subscribers;
calculating a total reduction in capacity due to the link failure;
collecting pricing plan information from the network service provider;
calculating a revenue generated by the network service provider for providing full service to each of the affected subscribers;
calculating a reduction in revenue to the network service provider for providing less than full service to each of the affected subscribers;
analyzing projected charges for the selected subscriber, using the subscriber profile, under the pricing plan information from the second first network service provider; and
allocating the total reduction in capacity to the affected subscribers based on the calculated revenue and reduction in revenue for each of the affected subscribers so that total revenue to the network service provider is maximized.

2. The method of claim 1, further comprising generating statistical data from the collected subscriber usage data using a statistical model comprising at least one of a histogram, an ordered histogram, a probability density function and a cumulative probability distribution function and determining the allocation of the total reduction in capacity to the affected subscribers based on the generated statistical data.

3. The method of claim 2, further comprising storing only the statistical data.

4. The method of claim 2, further comprising deleting the subscriber usage data after storing the statistical data.

5. The method of claim 2, further comprising collecting a second set of usage data and updating the statistical data using the second set of critical usage data.

6. The method of claim 2, wherein generating the statistical data comprises generating the statistical data in real time.

7. The method of claim 1, wherein allocating the total reduction in capacity to the affected subscribers includes denying some of the affected subscribers service while proving other of the affected subscribers full service.

8. The method of claim 7, wherein allocating the total reduction in capacity to the affected subscribers includes reducing service for all of the affected subscribers by an equal percentage.

9. The method of claim 2, further comprising using the statistical model to perform interactive analysis of the usage data.

10. The method of claim 1, wherein allocating the total reduction in capacity to the affected subscribers includes allocating the total reduction in capacity to the affected subscribers in real time.

11. The method of claim 1, wherein the network comprises an Internet network.

12. The method of claim 1, wherein the network comprises a wireless telephone network.

13. A network usage analysis system comprising:
a data collector coupled to a network comprising a plurality of links, wherein the data collector collects subscriber usage data corresponding to identification of subscribers using a failed link, and such subscriber usage data corresponding to identification of a pricing plan to which subscribers using the failed link belong; and
a system server coupled to the data collector, wherein system server receives the subscriber usage data from the data collector, receives identification of a link failure, receives pricing plan information identifying amounts paid by subscribers for service, and receives pricing plan information identifying an amount refunded to subscribers for less than full service, wherein the system server calculates revenue generated from each of the subscribers using a failed link, and wherein the system server allocates a reduced capacity to the subscribers using the failed link in a manner to maximize revenue.

14. The system of claim 13, wherein the system server generates statistical data based on the usage data and on a predefined statistical model comprising at least one of a histogram, an ordered histogram, a probability density function and a cumulative probability distribution function and the system server allocates the reduced capacity to the subscribers using the failed link based on the generated statistical data.

15. The system of claim 14, further comprising a data storage system for storing only the statistical data.

16. The system of claim 14, wherein the system server updates the statistical data using additionally collected usage data.

17. The system of claim 15, wherein the data storage system includes random access memory.

18. The system of claim 15, wherein the data storage system includes a hard disk drive or other persistent storage device.

20. The system of claim 14, further comprising a user interface operably coupled to the system server.

21. The system of claim 20, wherein the system server is responsive to the user interface for interactive analysis of the statistical model.

22. The system of claim 14, further comprising a display system for displaying the statistical model.

23. The system of claim 14, wherein the statistical model is in the form of a table.

24. The system of claim 14, wherein the table is a distribution table.

25. The system of claim 13, wherein the network is an Internet network.

26. The system of claim 13, wherein the network is a wireless telephone network.

27. A computer readable medium containing instructions for controlling a computer system to perform a method for maximizing revenue to a network service provider that provides access for subscribers to a network system, which includes a plurality of links, comprising the steps of:
identifying a failed link in the network system, the failed link causing reduced transmission capacity over the failed link;
identifying affected subscribers, wherein the affected subscribers are those subscribers of the network service provider that transmit over the failed link;
collecting network subscriber usage data from the network for the affected network subscribers;
calculating a total reduction in capacity due to the link failure;
collecting pricing plan information from the network service provider;
calculating a revenue generated by the network service provider for providing full service to each of the affected subscribers;
calculating a reduction in revenue to the network service provider for providing less than full service to each of the affected subscribers;
analyzing projected charges for the selected subscriber, using the subscriber profile, under the pricing plan information from the second first network service provider; and
allocating the total reduction in capacity to the affected subscribers based on the calculated revenue and reduction in revenue for each of the affected subscribers so that total revenue to the network service provider is maximized.

28. The computer readable medium of claim 27, further comprising generating statistical data from the collected subscriber usage data using a statistical model comprising at least one of a histogram, an ordered histogram, a probability density function and a cumulative probability distribution function and allocating the total reduction in capacity to the affected subscribers using the generated statistical data.

29. The computer readable medium of claim 28, further comprising storing only the statistical data
